(19) United States
(12) Patent Application Publication
(10) Pub. No.: US 2010/0127047 A1
(43) Pub. Date: May 27, 2010

(54) METHOD OF INHIBITING A FORMATION OF PALLADIUM-NICKEL-TIN INTERMETALLIC IN SOLDER JOINTS

(75) Inventors: Cheng-En Ho, Taoyuan County (TW); Wei-Hsiang Wu, Taoyuan County (TW); Cheng-Shiuan Lin, Taoyuan County (TW)

Correspondence Address: J C PATENTS, 4 VENTURE, SUITE 250, IRVINE, CA, 92618, US

(73) Assignee: Yuan Ze University, Taoyuan County (TW)

(21) Appl. No.: 12/352,979

(22) Filed: Jan. 13, 2009

(30) Foreign Application Priority Data
Nov. 25, 2008 (TW) 97145555

(51) Int. Cl. B23K 31/02

(52) U.S. Cl. 228/198

(57) ABSTRACT

A method of inhibiting a formation of palladium-nickel-tin (Pd—Ni—Sn) intermetallic in solder joints is described as follows. Firstly, a solder alloy is provided. Then, at least one of a trace of copper and a trace of zinc is doped into the solder alloy. Afterward, the solder alloy is disposed on the Pd-bearing surface finish, such as a Pd/Ni bi-layer or a Au/Pd/Ni tri-layer. Next, the solder alloy is soldered with the surface finish as solder joints. During the soldering, the Cu and Zn will incorporate into the soldering reaction, forming copper-palladium-nickel-tin intermetallic and zinc-palladium-nickel-tin intermetallic, replacing the Pd—Ni—Sn respectively. Consequently, the addition of Cu and/or Zn into solders will inhibit the undesirable Pd—Ni—Sn intermetallic to form in the solder joints.

### CROSS-REFERENCE TO RELATED APPLICATION

This application claims the priority benefit of Taiwan application serial no. 97145555, filed on Nov. 25, 2008. The entirety of the above-mentioned patent application is hereby incorporated by reference herein and made a part of specification.

### BACKGROUND OF THE INVENTION

1. Field of the Invention

The present invention relates to a method of preventing the solder/pad interface of a solder joint from being brittle. More specifically, the present invention relates to a method of inhibiting the formation of palladium-nickel-tin intermetallic in a solder joint by doping a trace of copper or a trace of zinc to the solder.

2. Description of Related Art

Printed circuit boards (PCB) and chip carrier substrates have a plurality of Cu metallization pads. In order to improve the characteristic of jointing with solders, they are typically electroplated or electroless plated a surface finish before soldering. One of the most common surface finishes used in the modem microelectronic devise is the palladium (Pd)-bearing metallization, such as a palladium/nickel (Pd/Ni) bi-layer or a gold/nickel/palladium (Au/Pd/Ni) tri-layer finish over the bare Cu circuits of PCB. This is because the Pd is identified to be a good oxidation resistance and have an excellent compatibility with both soldering and wire-bonding processes, so as to increase the reliability during joints fabrication.

FIG. 1A shows a schematic cross-sectional view of a conventional solder joint after soldering. FIG. 1B shows a schematic cross-sectional view of the solder joint in FIG. 1A after thermal treatment. Referring to FIG. 1A, a surface finish 110 is disposed on a pad P and a solder joint 120 is disposed on the surface finish 110. After soldering, there is palladium-nickel-tin (Pd—Ni—Sn) intermetallic 122 distributed in the solder joint 120. The elements palladium and nickel of the intermetallic 122 resulted from the surface finish 110 dissolution during soldering. Moreover, the nickel in the surface finish 110 would react with the solder, forming nickel-tin (Ni₃Sn₄) intermetallic layer 124 at the interface between the surface finish 110 and the solder joint 120.

Then, referring to FIG. 1B, the Pd—Ni—Sn intermetallic 122 would gradually migrate to and regroup at the solder/pad interface after the solid-state aging of the solder joint 120 (that is, simulating the condition of the solder joint after electronic devices have been operated at a high temperature for a long time). The Pd—Ni—Sn intermetallic 122 then forms a Pd—Ni—Sn continuous layer 122a over the Ni₃Sn₄ intermetallic layer 124. Since the interface F between the Ni₃Sn₄ intermetallic layer 124 and the Pd—Ni—Sn intermetallic layer 122a is brittle, the formation of the interface F will seriously deteriorate the reliability and the strength of the solder joint 120, resulting in a potential failure of an electronic device after experiencing a mechanical shock scenario.

To solve the issue caused by the Pd—Ni—Sn intermetallic 122 in the solder joint 120, one of the possible solutions is to reduce the thickness of the palladium plated layer (A typical palladium thickness ranges from 0.05˜0.3 μm), so as to reduce the quantity of the Pd—Ni—Sn intermetallic 122 formed in the solder joint 120. As a result, the probability of the Pd—Ni—Sn intermetallic 122 regrouped at the solder/Ni₃Sn₄ interface will be reduced thereof, which in turn prevents the solder/pad interface from being brittle. However, this method has the following three disadvantages: (i) A thin palladium layer is easy to expose the pad P or the underneath metal to the air if the palladium layer is not dense enough, (ii) the wire-bond reliability will decrease in a certain extain, (iii) the formation of the Pd—Ni—Sn intermetallic 122 cannot be eliminated completely and the presence of the Pd—Ni—Sn intermetallic 122 in the solder joint 120 still may deteriorate the overall strength of the solder joint 120 eventually.

Moreover, with the trend of the electronic devices advancing to be light, thin, and compact, the package size or the pin pitch will be substantially reduced in the future. This trend will cause the solder joint size to reduce as well in order to meet the requirement of the fine-pitch packaging. In addition, the reduction in solder joint sizes will magnify the effect of the Pd—Ni—Sn intermetallic due to the fact as follows.

It is known that the diameter of flip chip solder joints used currently is approximately 100 μm. Due to the sphere volume is proportional to the cube of the diameter, the volume of the solder joint is approximately 1/125 as compared to a 500 μm solder joint used in ball-grid-array (BGA) package. However, the volume of the surface finish is just proportional to the square of the pad diameter due to the disk-like geometry of pads. Hence the volume of the palladium layer is just 1/25 of the ones used in BGA package, assuming the thicknesses of the palladium finish in both flip chip and BGA substrate are the same. As a result, with the joint sizes reducing from BGA to flip chip scale, the solder volume actually reduces in a larger extent. In other words, a smaller joint has a higher proportion of the Pd—Ni—Sn intermetallic in the solder matrix than a larger one. It therefore can be expected that the brittle effect resulted from the Pd—Ni—Sn intermetallic will be magnified with shrinking the package dimensions/joint sizes.

### SUMMARY OF THE INVENTION

The present invention provides a method of inhibiting a formation of palladium-nickel-tin (Pd—Ni—Sn) intermetallic in solder joints to increase the reliability of a solder/pad interface.

The present invention provides a method of inhibiting the formation of palladium-nickel-tin intermetallic in solder joints. Firstly, a solder alloy is provided. Next, at least one of a trace of copper and a trace of zinc is doped into the solder alloy. Then, the solder alloy is disposed on a surface finish of Pd/Ni or Au/Pd/Ni. Afterward, the solder alloy is soldered with the surface finish to form a solder joint. During the soldering, the Pd and few Ni of the surface finish will dissolve into the solder. They would then form copper-palladium-nickel-tin (Cu—Pd—Ni—Sn) intermetallic or zinc-palladium-nickel-tin (Zn—Pd—Ni—Sn) intermetallic in the solder matrix during the solidification of soldering. Alternatively, copper-zinc-palladium-nickel-tin (Cu—Zn—Pd—Ni—Sn) intermetallic is formed by reacting with both copper and zinc. Consequently, the formation of the undesired Pd—Ni—Sn intermetallic in the solder joint can be inhibited.

In one embodiment of the present invention, the doped copper content is 0.05 wt. %-5 wt. % of the solder alloy.

In one embodiment of the present invention, the doped zinc content is 0.05 wt. %-10 wt. % of the solder alloy.

In one embodiment of the present invention, a material of the solder alloy includes a lead-tin alloy, a tin-silver alloy, a bismuth-tin alloy, or a combination thereof.

In one embodiment of the present invention, the surface finish is a palladium/nickel bi-layer or a gold/palladium/nickel (Au/Pd/Ni) tri-layer.

In summary, the prevent invention inhibits the formation of the brittle Pd—Ni—Sn intermetallic in the solder joint by doping at least one of a trace of copper or a trace of zinc into the solder to increase the reliability of the solder/pad interface.

In order to make the aforementioned and other features and advantages of the present invention more comprehensible, an embodiment accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A shows a schematic cross-sectional view of a conventional solder joint after soldering.

FIG. 1B shows a schematic cross-sectional view of the solder joint in FIG. 1A after a thermal treatment.

FIG. 2A shows a schematic cross-sectional view of the solder joint after soldering according to one embodiment of the present invention.

FIG. 2B shows a schematic cross-sectional view of the solder joint in FIG. 2A after a thermal treatment.

### DESCRIPTION OF EMBODIMENTS

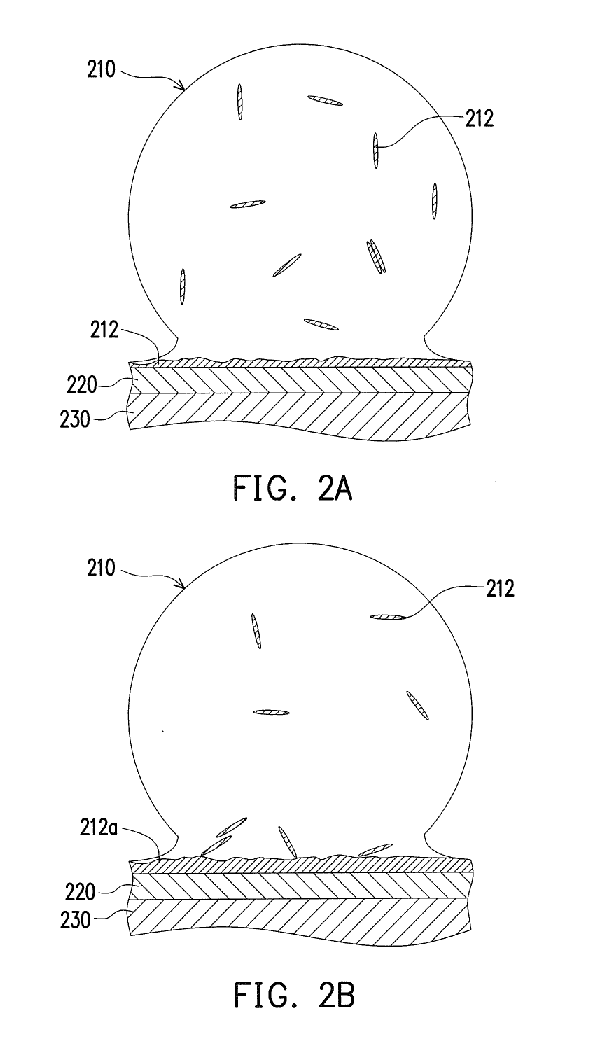

FIG. 2A shows a schematic cross-sectional view of the solder joint after soldering according to one embodiment of the present invention. FIG. 2B shows a schematic cross-sectional view of the solder joint in FIG. 2A after a thermal treatment.

A method of inhibiting a formation of a palladium-nickel-tin (Pd—Ni—Sn) intermetallic in a solder joint in the present embodiment is illustrated as follows.

Firstly, a solder alloy is provided. A material of the solder includes a lead-tin alloy, a tin-silver alloy, a bismuth-tin alloy, a combination thereof, or other suitable tin alloys. Next, at least one of a trace of copper and a trace of zinc is doped into the solder alloy. The doped copper content is 0.05 wt. %-5 wt. %, and the doped zinc content is 0.05 wt. %-10 wt. %.

Then, referring to FIG. 2A, the solder alloy is disposed on a Pd-bearing surface finish 220. The surface finish 220 may be a Pd/Ni bi-layer or a Au/Pd/Ni tri-layer. The surface finish 220 can be disposed on a pad 230 as the surface finish of the pad 230. A material of the pad 230 is a material with good conductive characteristics, for example, copper.

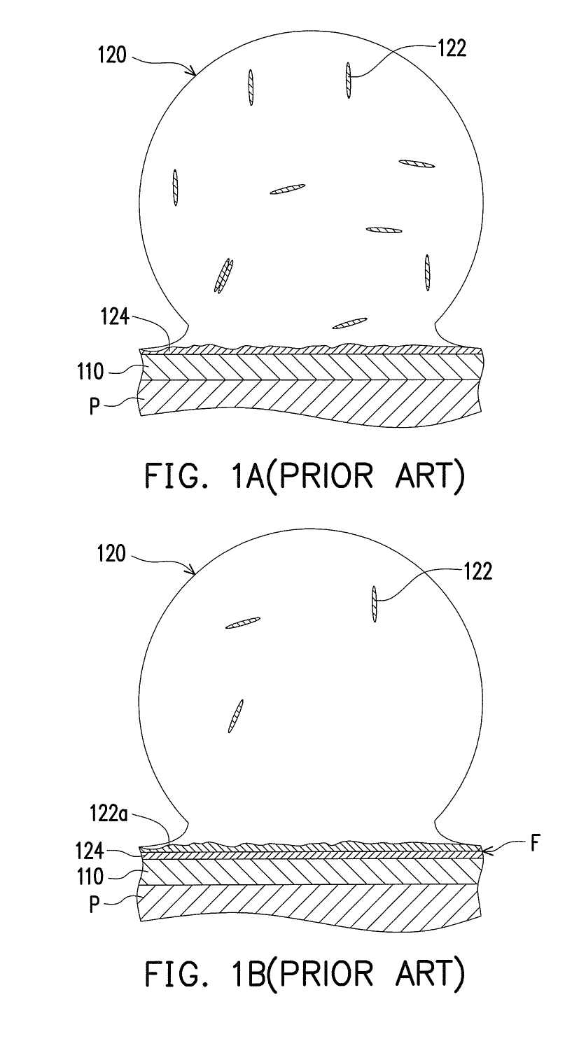

Then, the solder alloy is soldered with the surface finish 220 as a solder joint 210. Moreover, the formation of the copper-palladium-nickel-tin (Cu—Pd—Ni—Sn) intermetallic 212 or the zinc-palladium-nickel-tin (Zn—Pd—Ni—Sn) intermetallic (not shown) is formed by reacting copper or zinc with the solder alloy and the surface finish 220. Alternatively, the formation of the copper-zinc-palladium-nickel-tin (Cu—Zn—Pd—Ni—Sn) intermetallic (not shown) is formed by reacting copper and zinc with the solder alloy and the surface finish 220. Hence the Pd—Ni—Sn intermetallic embrittlement will no longer form in the conventional solder joints. In short, to dope at least one of copper and zinc into the solder alloy can effectively inhibit the formation of the brittle Pd—Ni—Sn/Ni₃Sn₄ interface F (FIG. 1B).

It should be noted that for illustrative convenience, in the present embodiment, doping a trace of copper is used as an example. When doping a trace of copper into the solder alloy, the solder alloy can form a copper-tin (Cu₆Sn₅) intermetallic, which reinforces the mechanical strength of the solder alloy as well.

FIG. 2B is a schematic microstructure drawing showing the solder joint 210 after being used for a long term under a high temperature. The interface of the solder joint 210 and the surface finish 220 will only form a Cu—Pd—Ni—Sn intermetallic layer 212a, a Zn—Pd—Ni—Sn intermetallic layer (not shown) or a Cu—Zn—Pd—Ni—Sn intermetallic (not shown), instead of forming the combination of a Pd—Ni—Sn intermetallic and a Ni₃Sn₄ intermetallic due to the fact that Cu, Zn, or both of them are doped.

In summary, the prevent invention inhibits the formation of the brittle Pd—Ni—Sn intermetallic in the solder joint by doping at least one of a trace of copper and a trace of zinc into the solder alloy will increase the reliability of the solder/pad interface. Moreover, as the method in the present invention is compatible with the conventional solder joint manufacturing process, the method of the present invention has high practicability.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

1. A method of inhibiting a formation of palladium-nickel-tin intermetallic in solder joints, comprising:
providing a solder alloy;
doping 0.5 wt % of copper into the solder alloy;
disposing the solder alloy on a surface finish comprising gold/palladium/nickel; and
soldering the solder alloy to form a solder joint and forming copper-palladium-nickel-tin intermetallic through reacting with the copper in the solder alloy; and
performing a thermal treatment on the solder joint, wherein neither the undesired palladium-nickel-tin intermetallic nor a palladium-nickel-tin/Ni₃Sn₄ interface is formed.

2-3. (canceled)

4. The method of inhibiting the formation of the palladium-nickel-tin intermetallic in the solder joint as claimed in claim 1, wherein a material of the solder alloy comprises a lead-tin alloy, a tin-silver alloy, or a combination thereof.

5. The method of inhibiting the formation of palladium-nickel-tin intermetallic in the solder joint as claimed in claim 1, wherein the surface finish is nickel-palladium-gold tri-layer.
